(19) United States
(12) Patent Application Publication
(10) Pub. No.: US 2007/0254713 A1
(43) Pub. Date: Nov. 1, 2007

(54) System and method for managing operation of a system based at least in part on a component of the system being physically accessible

(76) Inventors: Isaac Lagnado, Fort Collins, CO (US); Timothy Neill, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/413,948

(22) Filed: Apr. 28, 2006

(51) Int. Cl. H04M 3/16; H04B 1/38; H04M 1/68

(52) U.S. Cl. 455/558; 455/410

(57) ABSTRACT

A system of one embodiment comprises a first component; and a second component that, when in a first state, restricts physical access of the first component by a user, and when the second component is in a second state the second component permits physical access of the first component by the user. The system further comprises logic that, responsive to the second component transitioning from the first state to the second state, triggers disabling of at least one function of the system while permitting at least a second function of the system to remain enabled. In certain embodiments, the first component comprises a subscriber identity module (SIM), and wireless communication is disabled responsive to the second component transitioning to the second state.

### BACKGROUND OF THE INVENTION

Wireless communication devices, such as mobile telephones, often include a subscriber identity module (SIM). In general, the SIM identifies the mobile subscriber to the network. The SIM typically contains a personal identification number of the subscriber and identifies the network to which the subscriber belongs (e.g., identifies the subscriber's account with a wireless service provider, etc.). Typically, the SIM provides secure storing of a key identifying a wireless service (e.g., wireless phone) subscriber. Additionally, the SIM may contain subscription information, preferences, storage of text messages, and/or other information.

SIMs are most widely used in GSM (Global System for Mobile communication) systems, but various other types of SIMs are also known for identifying wireless subscribers. As one example, the Universal Subscriber Identity Module (USIM) is sometimes used in UMTS (Universal Mobile Telecommunications System). As another example, ISIM (IP Multimedia Services Identity Module) is another type of SIM. ISIM generally refers to an application running on a Universal Integrated Circuit Card (UICC) smartcard in a 3G telephone in the IP Multimedia Subsystem (IMS). ISIM typically contains parameters for identifying and authenticating the user to the IMS. The ISIM application can co-exist with other types of SIMs (e.g., USIM) on the same UICC, thus making it possible to use the same smartcard in both GSM networks and earlier releases of UMTS. As yet another example, W-SIM is a type of SIM which also includes the core components of a cellular telephone, such as the radio and transmitter. Except where accompanying language expressly specifies otherwise herein, “SIM” (or “subscriber identity module”) is used broadly to refer to any such module in any wireless communication system that identifies the mobile subscriber, including without limitation ISIMs, USIMs, and W-SIMs.

SIM is generally a logical application running on a physical card, such as a UICC smartcard. In most applications, the SIM stores network state information such as its current location area identity (LAI). If the wireless communication device (e.g., handset) is turned off and back on again, the device will access data from the SIM and search for the LAI it was in. This saves time by avoiding having to search the whole list of frequencies that the telephone normally would. Generally, each SIM is uniquely identified by its ICCID (International Circuit Card ID).

In many devices, the SIM may be removable from such device. Such removable SIMs may be referred to as Removable User Identity Modules (RUIMs). A SIM may, for example, be interchangeably used in a variety of different devices. For example, a subscriber may interchangeably use a SIM in both a mobile telephone and a laptop computer, to enable wireless communication via both devices through the subscriber's wireless service provider. As another example, a subscriber may have a plurality of accounts, each with a different SIM. For instance, a subscriber may have a first SIM for a business account and a second SIM for a personal account, whereby the subscriber may interchange the SIMs in a wireless communication device depending on the nature of the communication being conducted (e.g., whether business or personal). To prevent fraud or misuse of the SIM card, service providers typically desire that a SIM remain coupled to the wireless communication device at all times during wireless communication sessions. Removable SIM cards are commonly positioned in a wireless communication device, such as a cellular telephone, behind the wireless communication device's battery. Thus, a user is required to first remove the wireless communication device's battery in order to physically access the SIM card. Further, because certain wireless communication devices (e.g., certain mobile telephones) only operate via battery power, the power is necessarily turned off to the device prior to the SIM card being removed (i.e., because the device's battery is first removed to permit physical access to the SIM card). As such, the issue of a SIM being connected when establishing a wireless communication session, and then removed without terminating the wireless communication session, has been avoided in the above-mentioned wireless communication device configurations because the wireless communication device is first powered off (by removal of the battery) before the SIM is physically accessed.

However, many wireless communication devices now also offer functionality other than wireless communication. For instance, many wireless communication devices, such as laptop computers, notebook computers, tablet computers, personal data assistants (PDAs), text messaging devices, and even mobile telephones, offer various off-line functions to a user that do not require wireless communication. Such off-line functions may include, as examples, word processing, calendar application, address book application, etc. Thus, it is becoming desirable to enable such off-line functions to remain available even if a SIM card is removed from the device.

Additionally, many wireless communication devices also enable power from an alternative power supply even when the device's battery is removed. For instance, such devices may enable power from an external power source (e.g., Alternating Current (AC) power) to power their operability even when their batteries have been removed. As such, positioning the SIM card behind such a wireless communication device's battery supply no longer guarantees that the device will be powered down prior to removal of the SIM card. As such, these devices are susceptible to fraud or other misuse of the SIM card, and/or corruption of the SIM card if the SIM card is not properly shut down prior to being removed (e.g., if the SIM card is in the process of updating when it is removed).

### BRIEF DESCRIPTION OF THE DRAWINGS

FIG. 1 shows an exemplary system according to one embodiment of the present invention;

FIG. 2 shows an exemplary wireless communication system according to one embodiment of the present invention;

FIG. 3 shows another exemplary wireless communication system according to an embodiment of the present invention;

FIG. 4 shows still another exemplary wireless communication system according to an embodiment of the present invention;

FIG. 5 shows an exemplary operational flow of a wireless communication system according to one embodiment of the present invention;

FIG. 6 shows an operational flow of one embodiment of the present invention; and

FIG. 7 shows an operational flow of another embodiment of the present invention.

### DETAILED DESCRIPTION

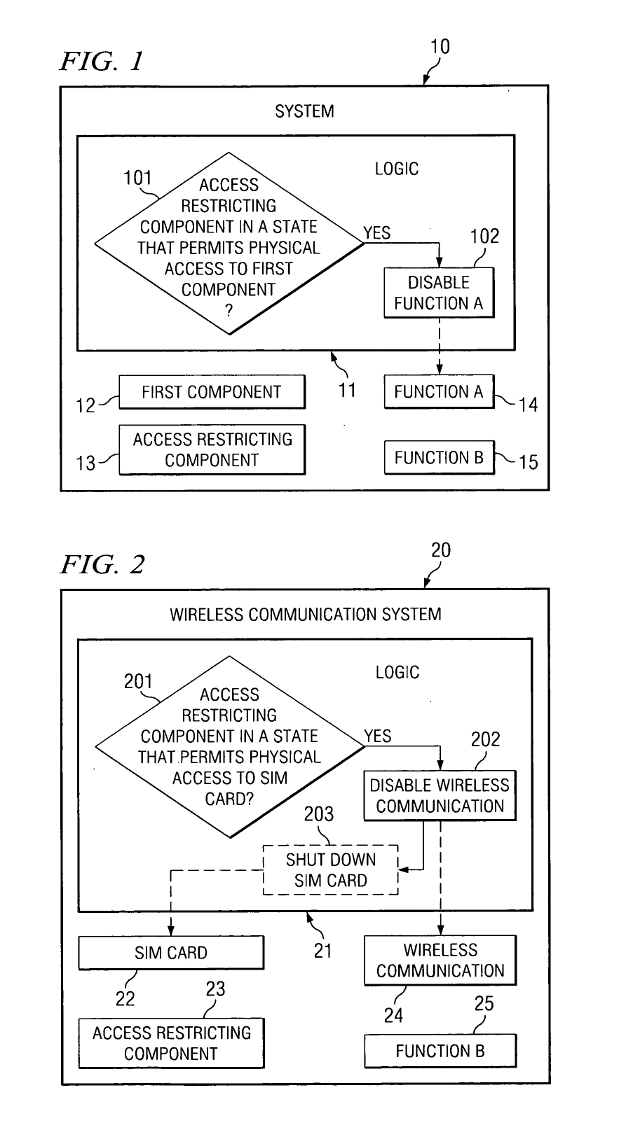

FIG. 1 shows an exemplary system 10 according to one embodiment of the present invention. System 10 comprises logic 11, first component 12, and access restricting component 13. Further, in this example, system 10 provides functionality “A” 14 and functionality “B” 15. As an example, functionality A 14 may be wireless communication, while functionality B 15 may be off-line functionality. System 10 may comprise any type of system, such as a mainframe computer, server computer, personal computer (PC), workstation, laptop computer, notebook computer, tablet computer, PDA, mobile telephone, text messaging system, other processor-based system, etc. In certain embodiments, system 10 is a portable computing system, and in certain embodiments system 10 is further a wireless communication system that supports wireless communication.

In this exemplary embodiment, access restricting component 13 restricts physical access by a user to first component 12. Access restricting component 13 may have a plurality of different states. For instance, access restricting component 13 may have a first state that restricts physical access of first component 12 by a user, and access restricting component 13 may have at least a second state that permits physical access of first component 13 by the user. For instance, access restricting component 13 may, in one exemplary implementation, comprise a door that when closed (e.g., in a first state) restricts physical access to first component 12, but when opened (e.g., in a second state) permits physical access to first component 12. As another example, access restricting component 13 may, in another exemplary implementation, comprise a functional component of system 10 behind which first component 12 is arranged. For instance, similar to the configurations mentioned above, access restricting component 13 may comprise a battery behind which first component 12 is arranged. Thus, in such an exemplary implementation, when restricting component 13 is in place in the system (e.g., in a first state) it restricts physical access of first component 12 by a user, and when restricting component 13 is removed from the system (e.g., transitioned to a second state) it permits physical access of first component 12 by the user. As still another example, access restricting component 13 may, in another exemplary implementation, comprise an eject button that when not depressed (e.g., in a first state) restricts physical access of first component 12 by a user, and when such eject button is depressed (e.g., transitioned to a second state) it permits physical access of first component 12 by the user (e.g., ejects first component 12 from the system). Any other mechanism that comprises a first state for restricting a user's physical access of first component 12 and at least a second state that permits physical access of first component 12 may be employed for implementing access restricting component 13.

Logic 11 may comprise hardware, software, firmware, or any combination thereof for implementing its functionality. In this embodiment, logic 11 determines in operational block 101 whether access restricting component 13 is in a state that permits physical access to first component 12. If it is determined that access restricting component 13 is in such a state, operation of logic 11 advances to block 102 whereat it disables function A 14. In certain embodiments, function A 14 may comprise wireless communication that is disabled in block 102. For instance, a network connection to a wireless communication network may be terminated and not permitted to be established by the system 10 in block 102.

Thus, responsive to the access restricting component 13 transitioning from a first state that restricts physical access of first component 12 to a second state that permits physical access of first component 12, logic 11 triggers disabling of at least one function of system 10 (e.g., function A 14 in this example) while permitting at least a second function (e.g., function B 15 in this example) of system 10 to remain enabled. While two exemplary functions 14 and 15 are shown in this FIGURE, it should be understood that any number of functions may exist in a system and be managed in the manner described herein.

FIG. 2 shows an exemplary wireless communication system 20 according to one embodiment of the present invention. System 20 comprises logic 21, SIM card 22, and access restricting component 23. Further, in this example, system 20 provides wireless communication functionality 24, as well as other (e.g., off-line) functionality 25. System 20 may comprise any type of system that provides wireless communication. In certain embodiments, system 20 is a portable computing system that supports wireless communication (e.g., a laptop computer, notebook computer, tablet computer, PDA, mobile telephone, portable text messaging system, etc.).

In this exemplary embodiment, access restricting component 23 restricts physical access by a user to SIM card 22. As with access restricting component 13 described above with FIG. 1, access restricting component 23 may have a plurality of different states. For instance, access restricting component 23 may have a first state that restricts physical access of SIM card 22 by a user, and access restricting component 23 may have at least a second state that permits physical access of SIM card 22 by the user. Such access restricting component 23 may comprise a door, another component behind which SIM card 22 is arranged, an eject button, or any other mechanism that comprises a first state for restricting a user's physical access of SIM card 22 and at least a second state that permits physical access of SIM card 22.

As with logic 11 of FIG. 1, logic 21 may comprise hardware, software, firmware, or any combination thereof for implementing its functionality. In this embodiment, logic 21 determines in operational block 201 whether access restricting component 23 is in a state that permits physical access to SIM card 22. If it is determined that access restricting component 23 is in such a state, operation of logic 21 advances to block 202 whereat it disables wireless communication 24. Thus, responsive to the access restricting component 23 transitioning from a first state that restricts physical access of SIM card 22 to a second state that permits physical access of SIM card 22, logic 21 triggers disabling of wireless communication 24, while permitting at least functionality 25 (e.g., off-line functionality) of system 20 to remain enabled. Additionally, in certain embodiments, logic 21 may further shut down SIM card 22 in operational block 203. Such a shut down may be desirable to, for example, ensure safe removal of SIM card 22 and/or protect against corruption of the SIM card 22 by ensuring that the SIM card 22 is not removed during an update thereto. While two exemplary functions 24 and 25 are shown in this FIGURE, it should be understood that any number of functions may exist in a system and be managed in the manner described herein.

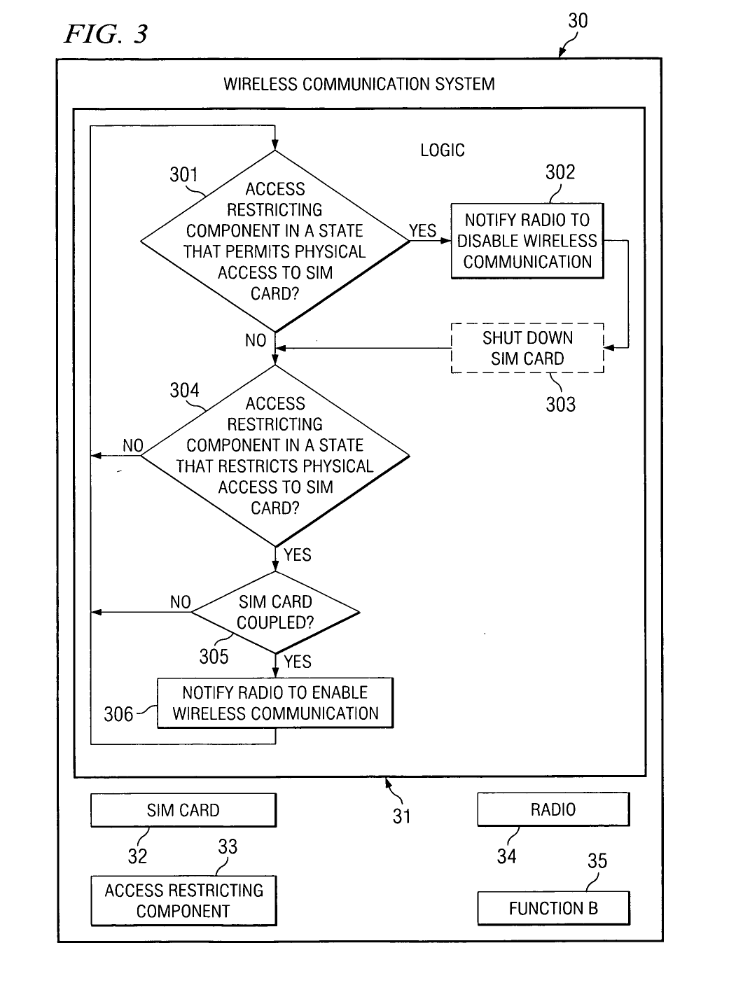

FIG. 3 shows another exemplary wireless communication system 30 according to an embodiment of the present invention. System 30 comprises logic 31, SIM card 32, and access restricting component 33. Further, in this example, system 30 comprises wireless communication mechanism 34 (e.g., receiver, transceiver, etc.) that enables wireless communication. Hereinafter, such wireless communication mechanism is generally referred to as a “radio,” which is intended to encompass any mechanism now known or later developed for enabling wireless communication. Additionally, system 30 further comprises other (e.g., off-line) functionality 35. System 30 may comprise any type of system that provides wireless communication. In certain embodiments, system 30 is a portable computing system that supports wireless communication (e.g., a laptop computer, notebook computer, tablet computer, PDA, mobile telephone, portable text messaging system, etc.).

In this exemplary embodiment, access restricting component 33 restricts physical access by a user to SIM card 32. As with access restricting component 13 described above with FIG. 1, access restricting component 33 may have a plurality of different states. For instance, access restricting component 33 may have a first state that restricts physical access of SIM card 32 by a user, and access restricting component 33 may have at least a second state that permits physical access of SIM card 32 by the user. Such access restricting component 33 may comprise a door, another component behind which SIM card 32 is arranged, an eject button, or any other mechanism that comprises a first state for restricting a user's physical access of SIM card 32 and at least a second state that permits physical access of SIM card 32.

As with logic 11 of FIG. 1, logic 31 may comprise hardware, software, firmware, or any combination thereof for implementing its functionality. In this embodiment, logic 31 determines in operational block 301 whether access restricting component 33 is in a state that permits physical access to SIM card 32. If it is determined that access restricting component 33 is in such a state, operation of logic 31 advances to block 302 whereat it notifies radio 34 to disable wireless communication. Thus, responsive to the access restricting component 33 transitioning from a first state that restricts physical access of SIM card 32 to a second state that permits physical access of SIM card 32, logic 31 triggers notification of radio 34 to disable wireless communication, while permitting at least functionality 35 (e.g., off-line functionality) of system 30 to remain enabled. Additionally, in certain embodiments, logic 31 may further shut down SIM card 32 in operational block 303. Such a shut down may be desirable to, for example, ensure safe removal of SIM card 32 and/or protect against corruption of the SIM card 32 by ensuring that the SIM card 32 is not removed during an update thereto.

Further, in this example, logic 31 determines in operational block 304 whether access restricting component 33 is in a state that restricts physical access to SIM card 32. If determined that access restricting component 33 is in such a state, operation of logic 31 advances to block 305 whereat it determines whether SIM card 32 is coupled to system 30. If determined in block 305 that SIM card 32 is coupled, operation advances to block 306 whereat logic 31 notifies radio 34 to enable wireless communication. Thus, responsive to the access restricting component 33 transitioning, when SIM card 32 is coupled to the system, to a first state that restricts physical access of SIM card 32, logic 31 triggers notification of radio 34 to enable wireless communication. While two exemplary functions (e.g., wireless communication supported by radio 34) and off-line function B 35 are shown in this FIGURE, it should be understood that any number of functions may exist in a system and be managed in the manner described herein.

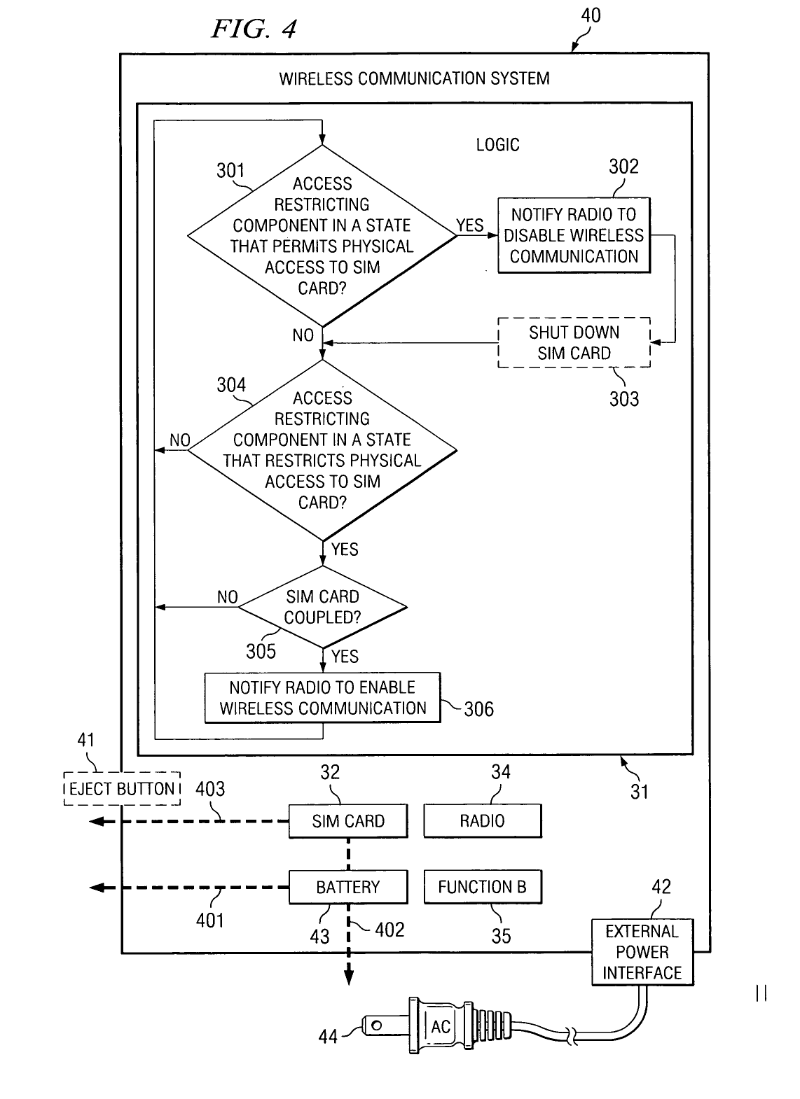

FIG. 4 shows still another exemplary wireless communication system 40 according to an embodiment of the present invention. As with system 30 described above in FIG. 3, system 40 comprises logic 31, SIM card 32, and radio 34 that enables wireless communication. Also like system 30, system 40 further comprises other (e.g., off-line) functionality 35. System 40 may comprise any type of system that provides wireless communication. In certain embodiments, system 40 is a portable computing system that supports wireless communication (e.g., a laptop computer, notebook computer, tablet computer, PDA, mobile telephone, portable text messaging system, etc.).

The exemplary system 40 comprises internal power supply (e.g., battery) 43. In certain embodiments, battery 43 acts as access restricting component 33 of FIG. 3. For instance, SIM card 32 may be arranged behind battery 43 such that battery 43 must be removed from system 40 in order to physically access SIM card 32. For instance, as illustrated in this example, in one embodiment battery 43 may be removed (as indicated by dashed arrow 401, thus permitting physical access to SIM card 32 (as indicated by dashed arrow 402). In other embodiments, some other type of access restricting component may be implemented instead of or in addition to battery 43. For instance, as further illustrated in FIG. 4, an eject button 41 may be implemented as such an access restricting component, which when depressed causes the SIM card 32 to be ejected from system 40 as indicated by dashed arrow 403.

Exemplary system 40 further comprises external power interface 42 for receiving power from an external power source, such as Alternating Current (AC) power source 44. In addition to or instead of external power interface 42, system 40 may include an alternative power source in addition to battery 43, such as another battery. Thus, even when battery 43 is removed from system 40 (e.g., to permit physical access to SIM card 32 in certain embodiments, as indicated by dashed arrows 401 and 402), system 40 can still receive power. Accordingly, when so powered by an alternate power source, system 40 can still support certain functions 35 even when battery 43 is removed. While two exemplary functions (e.g., wireless communication supported by radio 34) and off-line function B 35 are shown in this FIGURE, it should be understood that any number of functions may exist in a system and be managed in the manner described herein.

In one implementation, upon battery 43 transitioning from a first state (e.g., being coupled to system 40) that restricts physical access of SIM card 32 to a second state (e.g., being removed from system 40, as indicated by dashed arrow 401) that permits physical access of SIM card 32, logic 31 triggers notification of radio 34 to disable wireless communication, while permitting at least functionality 35 (e.g., off-line functionality) of system 40 to remain enabled, as described above with FIG. 3. Similarly, in an alternative implementation that comprises eject button 41, upon such eject button 41 transitioning from a first state (e.g., not being depressed) that restricts physical access of SIM card 32 to a second state (e.g., being depressed) that permits physical access of SIM card 32, logic 31 triggers notification of radio 34 to disable wireless communication, while permitting at least functionality 35 (e.g., off-line functionality) of system 40 to remain enabled. Thus, in either case, when physical access is permitted to SIM card 32, logic 31 notifies radio 34 to disable wireless communication.

For instance, battery 43 may be arranged to physically restrict access to SIM card 32 such that battery 43 must be removed from system 40 (as indicated by dashed arrow 401) before removing SIM card 32 (as indicated by dashed arrow 402). Of course, in this embodiment, system 40 may still be powered by an alternative power source even when battery 43 is so removed. Thus, logic 31 may notify radio 34 to disable wireless communication when battery 43 is removed, while permitting other functionality 35 of the system to remain enabled, as such other functionality 35 is powered via the alternative power source, such as external power source 44.

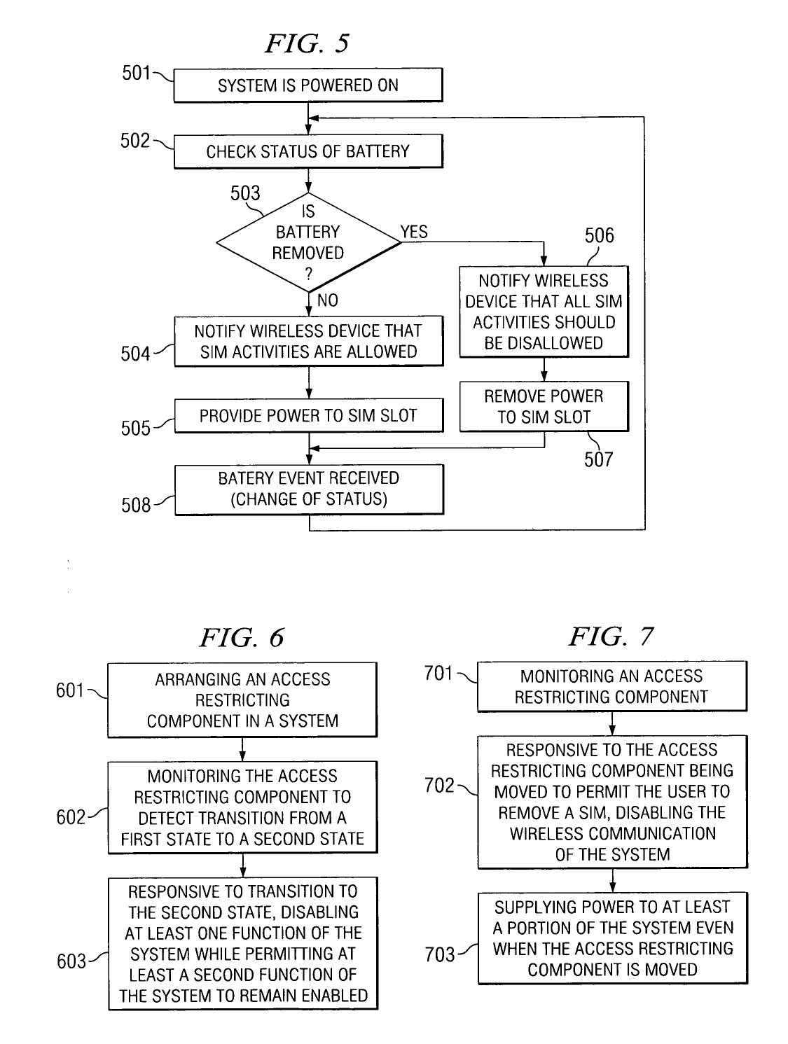

FIG. 5 shows an exemplary operational flow of a wireless communication system according to one embodiment of the present invention. In operational block 501, the system is powered on. In block 502, the status of a battery in the system is checked. For instance, in this example a battery may be arranged to physically restrict access to a SIM card, such as battery 43 in FIG. 4. Logic 31 may be implemented to check the status of such battery in block 502. For instance, in block 502, logic 31 may check whether a battery is present or absent. In block 503, logic 31 determines whether the battery is present in the system. That is, based on the status check in block 502, logic 31 can determine in block 503 whether the battery has been removed from the system. If the battery is not removed (i.e., is present in the system), operation advances to block 504 whereat logic 31 notifies the wireless device (e.g., radio 34 of FIG. 4) that SIM activities are allowed. In block 505, power is supplied to the SIM card. Such operation of the system persists and logic 31 monitors whether a battery event is received (e.g., indicating a change in status of the battery) in block 508 at which point operation returns to block 502 to again check the status of the battery.

If it is determined in block 503 that the battery is removed, operation advances to block 506 whereat logic 31 notifies wireless device (e.g., radio 34 of FIG. 4) that all SIM activities should be disallowed. In block 507 power is removed from the SIM card. Such operation of the system persists and logic 31 monitors whether a battery event is received (e.g., indicating a change in status of the battery) in block 508 at which point operation returns to block 502 to again check the status of the battery.

FIG. 6 shows an operational flow of one embodiment of the present invention. In operational block 601, an access restricting component (e.g., battery 43 or eject button 41 of FIG. 4) is arranged in a system such that the access restricting component, when in a first state, restricts a user from physically removing a first component (e.g., SIM card 32 of FIG. 4) from the system, and when the access restricting component is in at least a second state, the access restricting component permits a user to physically remove the first component from the system. In block 602, logic of the system (e.g., logic 31 of FIG. 4) monitors the access restricting component to detect when the access restricting component is transitioned from the first state to the at least a second state. In block 603, responsive to detecting that the access restricting component is transitioned from the first state to the at least a second state, the logic disables at least one function of the system (e.g., disables radio 34 of FIG. 4) while permitting at least a second function of the system (e.g., off-line function 35 of FIG. 4) to remain enabled.

FIG. 7 shows an operational flow of another embodiment of the present invention. Such operational flow restricts wireless communication by a system based on physical access to a SIM of the system. In block 701, logic of the system monitors an access restricting component that must be moved to permit a user to remove the SIM from the system. In block 702, responsive to the access restricting component being moved to permit the user to remove the SIM, the logic disables the wireless communication of the system. In block 703, power is supplied to at least a portion of the system even when the access restricting component is moved to permit the user to remove the SIM.

When implemented via computer-executable instructions, various elements of embodiments of the present invention, such as logic 11 of FIG. 1, logic 21 of FIG. 2, and logic 31 of FIGS. 3 and 4, are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information. Thus, the exemplary operations described above as being performed by such logic (e.g., the operational flows of FIGS. 5-7) may be implemented in a system via computer-executable software code. The software code may run on any suitable processor-based system, and the architecture of such processor-based system is of no limitation as long as it can support the novel operations described herein.

In view of the above, embodiments of the present invention provide a system and method for managing operation of a system based at least in part on a component of the system being physically accessible. For instance, certain embodiments of the present invention manage wireless communication of a wireless communication system based at least in part on whether a SIM card is physically accessible. In certain embodiments, an access restricting component is implemented in the system for restricting physical access of a SIM card, and logic is provided for selectively disabling certain functionality of the system, such as wireless communication, when the access restricting component is transitioned to a state that permits the SIM card to be physically accessed. In this regard, certain embodiments permit certain functionality of the system (e.g., off-line functionality and other functionality that is desired to be permitted when a given system component, such as a SIM card, is physically accessible) even when the access restricting component is transitioned to a state that permits the SIM card to be physically accessed.

Further, certain embodiments provided herein are not reliant solely on removal of power to the system for disabling wireless communication. As mentioned above, some wireless communication device configurations arrange the SIM card behind the device's battery such that the battery is required to be first removed before a user can physically access the SIM card. Certain embodiments of the present invention advantageously disable wireless communication functionality when physical access is permitted to the system's SIM card, while permitting power to remain supplied to the system (e.g., to power off-line functionality of the system). Further still, certain embodiments shut down the SIM card responsive to the access restricting component being transitioned to a state that permits the SIM card to be physically accessed. Thus, corruption of the SIM card due to unexpected removal thereof (e.g., removal while being updated) can be avoided.

Thus, some embodiments of the present invention are particularly applicable for managing wireless communication based at least in part on whether a SIM card is physically accessible in the system such that the SIM card may be removed. However, while much of the above description and exemplary embodiments are directed to managing wireless communication based at least in part on whether a SIM card is physically accessible, the concepts presented herein are likewise applicable to managing any other functionality of a given system based at least in part on whether any component of the system is physically accessible. Thus, while a wireless communication system is a special case in which embodiments of the present invention are particularly advantageous for managing wireless communication based at least in part on whether a SIM card is physically accessible, the concepts presented herein are not limited in application to such special case.

What is claimed is:

1. A system comprising:
a first component;
a second component that, when in a first state, restricts physical access of said first component by a user, and when said second component is in a second state said second component permits physical access of said first component by the user; and
logic that, responsive to said second component transitioning from said first state to said second state, triggers disabling of at least one function of said system while permitting at least a second function of said system to remain enabled.

2. The system of claim 1 wherein said disabling comprises shutting down said first component.

3. The system of claim 1 wherein said at least one function comprises a function that is desired to be provided by said system only when said first component is present in said system.

4. The system of claim 1 wherein said disabling comprises terminating a network connection.

5. The system of claim 1 further comprising:
a wireless communication device, wherein said disabling comprises notifying said wireless communication device to disable wireless communication.

6. The system of claim 1 wherein said first component comprises a subscriber identity module.

7. The system of claim 1 wherein said second state of said second component permits the user to physically remove said first component from said system.

8. The system of claim 1 wherein said second component is required to be physically moved to transition from said first state to said second state.

9. The system of claim 1 wherein said second component comprises a battery.

10. The system of claim 1 wherein said second component comprises a door.

11. The system of claim 1 wherein said second component comprises an eject button for ejecting said first component responsive to being pressed.

12. The system of claim 1 wherein said second component is movable between a first position and at least a second position; said first position comprising said first state; and said at least a second position comprising said second state.

13. The system of claim 12 wherein said at least a second position of said second component comprises removal of said second component from said system.

14. The system of claim 1 further comprising:
logic that, responsive to said second component transitioning to said first state, triggers enabling of said at least one function of said system.

15. A system comprising:
a first component;
an access restricting component that must be moved to permit a user to remove said first component from said system;
a wireless device that enables wireless communication;
logic that, responsive to said access restricting component being moved to permit the user to remove said first component, disables said wireless communication; and
at least one power source for supplying power to at least a portion of said system even when said access restricting component is moved to permit the user to remove said first component.

16. The system of claim 15 wherein said first component comprises a subscriber identity module (SIM).

17. The system of claim 16 wherein responsive to said access restricting component being moved to permit the user to remove said SIM, the logic shutting down said SIM.

18. The system of claim 15 wherein said at least one power source comprises an internal power source and an external power source.

19. The system of claim 18 wherein said access restricting component comprises said internal power source.

20. The system of claim 15 wherein said logic, responsive to said access restricting component being moved to permit the user to remove said first component, permits at least one function of said system, other than said wireless communication, to remain enabled.

21. A method comprising:
arranging an access restricting component in a system such that said access restricting component, when in a first state, restricts a user from physically removing a first component from said system, and when said access restricting component is in at least a second state, said access restricting component permits a user to physically remove said first component from said system; and
monitoring said access restricting component to detect when said access restricting component is transitioned from said first state to said at least a second state; and
responsive to detecting that said access restricting component is transitioned from said first state to said at least a second state, disabling at least one function of said system while permitting at least a second function of said system to remain enabled.

22. The method of claim 21 wherein said arranging said access restricting component in said system such that said access restricting component, when in said first state, restricts said user from physically removing said first component from said system comprises:
arranging said access restricting component in said system such that said access restricting component, when in said first state, restricts said user from physically removing a subscriber identity module (SIM).

23. The method of claim 22 wherein said disabling said at least one function of said system comprises:
disabling wireless communication.

24. The method of claim 23 further comprising:
enabling said wireless communication responsive to detecting that said access restricting component is transitioned to said first state when said SIM is coupled to said system.

25. The method of claim 21 further comprising:
responsive to detecting that said access restricting component is transitioned from said first state to said at least a second state, shutting down said first component.
